(19) United States
(12) Patent Application Publication
(10) Pub. No.: US 2013/0031020 A1
(43) Pub. Date: Jan. 31, 2013

(54) MARGIN AS CREDIT ENHANCEMENT CONTRACTS

(71) Applicants: David Boberski, Westport, CT (US); John Wiley, New York, NY (US); John Nyhoff, Darien, IL (US); John Labuszewski, Westmont, IL (US)

(72) Inventors: David Boberski, Westport, CT (US); John Wiley, New York, NY (US); John Nyhoff, Darien, IL (US); John Labuszewski, Westmont, IL (US)

(73) Assignee: Chicago Mercantile Exchange Inc., Chicago, IL (US)

(21) Appl. No.: 13/190,864

(22) Filed: Jul. 26, 2011

(51) Int. Cl. G06Q 40/00

(52) U.S. Cl. 705/36 R

(57) ABSTRACT

Systems and methods are provided for implementing risk retention programs for originators and securitizers of asset backed securities. An administrative contract identified as a margin as credit enhancement contract is created for a corresponding asset backed security. A risk retention entity is assigned a long position for the margin as credit enhancement contract corresponding to a predetermined percentage of the asset backed security. A buyer of the asset backed security is assigned a short position for the margin as credit enhancement contract. When the asset backed security expires, a computer device settles the long and short positions of the margin as credit enhancement contract.

### FIELD OF THE INVENTION

The present invention relates to asset backed security systems and methods. More particularly, the invention relates to mechanisms used to retain interests in asset backed securities.

### DESCRIPTION OF THE RELATED ART

Asset backed securities are securities that have values and/or income payment derived from and backed by a pool of underlying assets. Exemplary underlying assets include residential mortgages, commercial mortgages, credit card payments, automobile receivables, royalty payments and movie revenue. Pooling underlying assets into asset backed financial instruments is a process called securitization and allows the financial instruments to be sold to general inventors. Pooling of underlying assets also diversifies risks because each individual asset represents a fraction of the total value of the diverse pool of underlying assets.

Regulators of asset backed securities have expressed a desire to greater regulate the origination and securitization of asset back securities. Recent legislation in the United States, for example, includes risk retention requirements. The legislation mandates that originators and securitizers of asset backed securities retain a 5% interest in such securities. Originators and securitizers of asset backed securities may hold securities in multiple diverse accounts. Auditing multiple diverse accounts to make sure risk retention requirements are satisfied can be difficult and costly.

Therefore, there is a need in the art for systems and methods that can be used to implement risk retention requirements for asset backed securities.

### SUMMARY OF THE INVENTION

Embodiments of the present invention overcomes the problems and limitations of the prior art by providing methods and systems for implementing risk retention requirements for asset backed securities.

In one embodiment of the invention, a method of administering a margin as credit enhancement contracts is provided. A risk retention entity is assigned a long position for a margin as credit enhancement contract corresponding to a predetermined percentage of an asset backed security. A buyer of the asset backed security is assigned a short position for the margin as credit enhancement contract. When the asset backed security expires, a computer device settles the long and short positions of the margin as credit enhancement contract.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates a process for ensuring that a risk retention entity retains a financial interest in an asset backed security, in accordance with an embodiment of the invention; and

FIG. 3 illustrates a process for administering margin as credit enhancement contracts, in accordance with an embodiment of the invention.

### DETAILED DESCRIPTION OF THE INVENTION

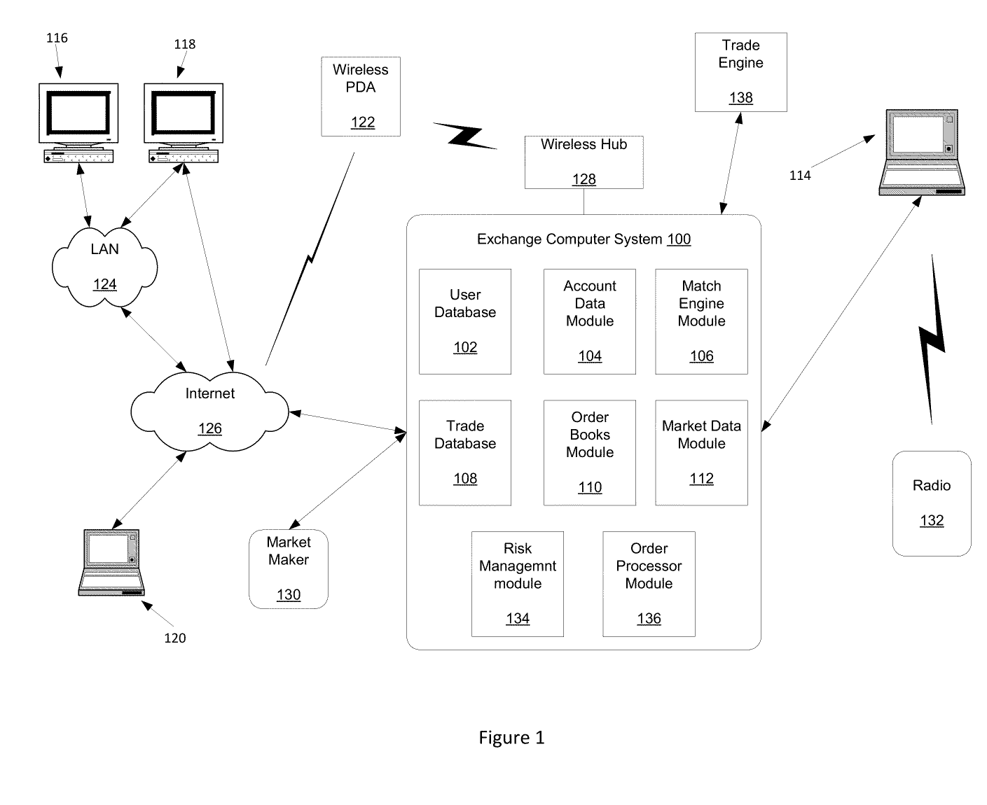

Aspects of the present invention may be implemented with computer devices and computer networks that allow users to exchange trading information. In particular, a trading network environment may be used to exchange and match bids and offers for the disclosed financial instruments. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to process orders for further processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

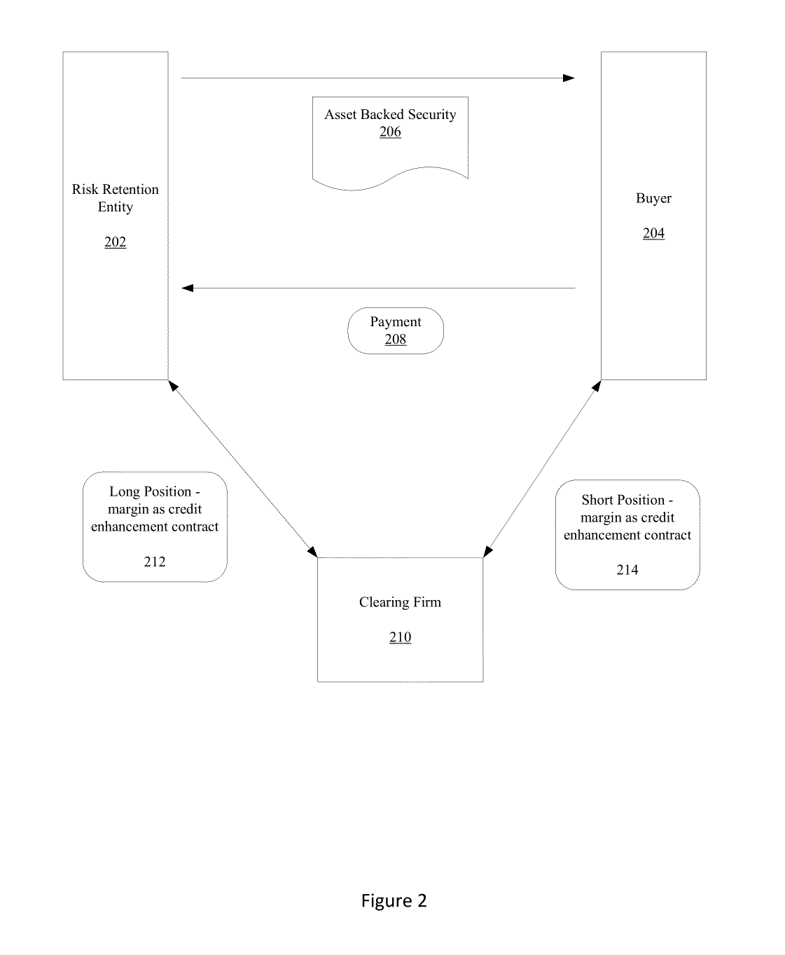

FIG. 2 illustrates a process for ensuring that a risk retention entity 202 retains a financial interest in an asset backed security 204. Risk retention entity 202 may be an originator and/or securitizer of asset backed security 204. In a first transaction, risk retention entity 202 may sell asset backed security 204 to a buyer 206. Asset backed security 204 may be a mortgage backed security, such as a residential mortgage backed security or a commercial mortgage backed security. Buyer 206 provides a payment 208 to risk retention entity 202 in exchange for asset backed security 204. One skilled in the art will appreciated that the sale of asset backed security 204 from risk retention entity 202 to buyer 206 may involve one or more other entity, such as an over the counter market or an exchange.

At the time of selling asset backed security 204 or shortly thereafter, risk retention entity 202 and buyer 206 establish margin as credit enhancement contract positions corresponding to the asset backed security. For example, risk retention entity may securitize a mortgaged backed security with a face value of $500 million and buyer 206 may purchase the mortgage backed security. A margin as credit enhancement contract corresponding to the mortgage backed security may be created with a nominal dollar value of $1,000. At the time of the sale of the mortgage backed security, a clearing firm 210 or other clearing or tracking entity may assign a long position of 500,000 margin as credit enhancement contracts to the account of risk retention entity 202 and a short position of 500,000 margin as credit enhancement contracts 214 to the account of buyer 206. The name of the margin as credit enhancement contract may correspond to the name of the mortgaged backed security. For example, a mortgage backed security may be named XYZ Mortgaged Backed Security and the corresponding margin as credit enhancement contract may be named XYZ MBS Margin as Credit Enhancement Contract.

Risk retention entities may be required to hold margin as credit enhancement contracts for the life of the corresponding asset backed security. In some embodiments, short margin as credit enhancement contract positions may be liquid and may be purchased and sold.

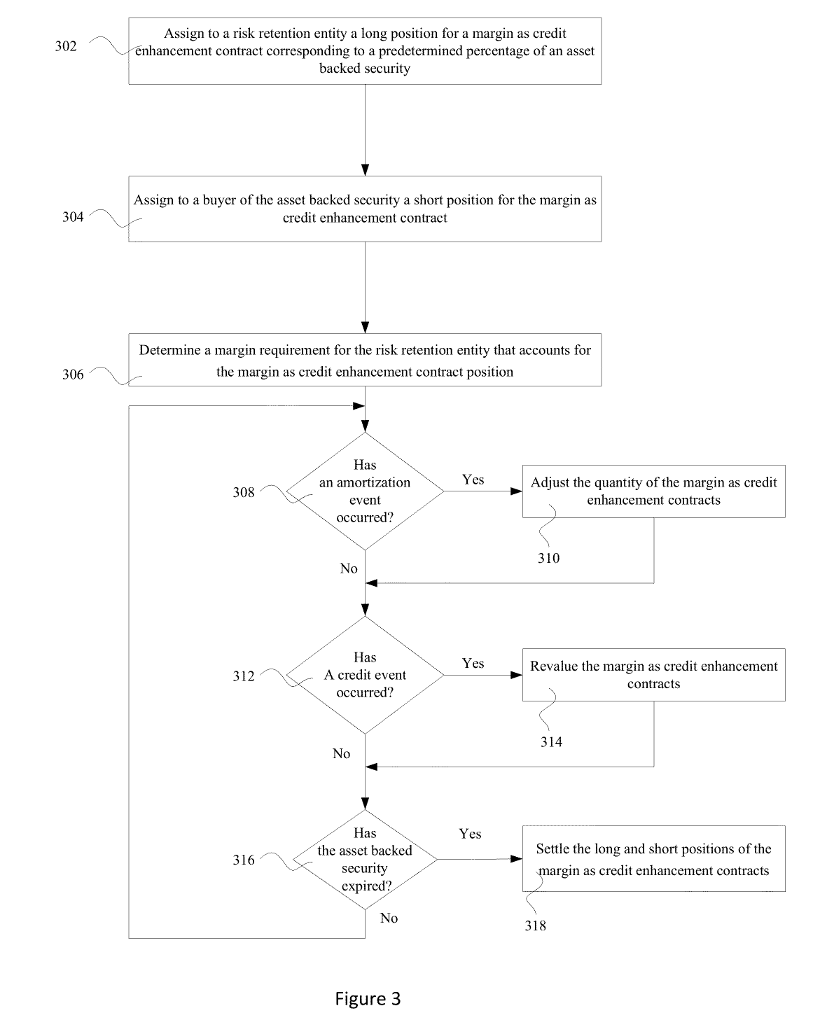

FIG. 3 illustrates a process for administering margin as credit enhancement contracts, in accordance with an embodiment of the invention. First, in step 302 a long position for a margin as credit enhancement contract corresponding to a predetermined percentage of an asset backed security is assigned to a risk retention entity. In step 304, a short position for the margin as credit enhancement contract is assigned to the buy the buyer of the asset backed security. Next, in step 306 a margin requirement for the risk retention entity is determined. The margin requirement may account for the margin as credit enhancement contract position. In some embodiments, the margin requirement may be determined by analyzing risks associated with multiple positions or an entire portfolio. Of course, a margin requirement may also be determined for a party holding a short position of margin as credit enhancement contracts. Margin requirements may be determined by a clearing house or other entity.

Margin as credit enhancement contracts may be settled when corresponding asset backed securities expire. Adjustments to the value of a margin as credit enhancement contract may be made before the expiration of a corresponding asset backed security when amortization events or credit events occur. In step 308 it is determined whether an amortization event has occurred. An amortization event may occur when a portion of a pool of underlying mortgages that form a mortgage backed security are prepaid. For example, a mortgage backed security may have an initial value of $500 million and mortgages having a total value of $200 million may be prepaid. When an amortization event has occurred, in step 310 the quantity of the margin as credit enhancement contracts is adjusted. If $200 million of an initial $500 pool of mortgages are prepaid and the corresponding margin as credit enhancement contracts had an initial quantity of 500,000, then 200,000 of the contracts may be liquidated or retired at their current market value.

Next, in step 312 it is determined whether a credit event has occurred. A credit event may be defined by an exchange or other entity. When a credit event has occurred, in step 314, the margin as credit enhancement contracts may be revalued. If, for example, a credit event results in a reduction of the value of an asset backed security by 10%, the value of the corresponding margin as credit enhancement contracts may be reduced by the same 10%. In some embodiments the value of margin as credit enhancement contracts is reduced by the same percentage as the reduction in value of the corresponding asset backed securities. A loss by the risk retention entity and profit by the buyer may be administered by a clearing firm or other entity. For example, if the change in value of the margin as credit enhancement contracts results in a loss of $100,000 to the risk retention entity and a profit of $100,000 to the buyer, a clearing house may adjust the accounts of the risk retention entity and buyer accordingly. The clearing house or other entity may make a mark-to-market payment from the account of the risk retention entity to the account of the buyer.

In step 316 it is determined whether an asset backed security has expired. When the asset back security has expired, a clearing house or other entity may settle the long and short positions of the margin as credit enhancement contracts. As mentioned above, settlement may include making a mark-to-market payment from the account of the risk retention entity to the account of the buyer. When the asset backed security has not expired, control may return to step 308.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

What is claimed is:

1. A method of administering a margin as credit enhancement contract comprising:
(a) assigning to a risk retention entity a long position for a margin as credit enhancement contract corresponding to a predetermined percentage of an asset backed security;
(b) assigning to a buyer of the asset backed security a short position for the margin as credit enhancement contract; and
(c) settling at a computer device the long and short positions of the margin as credit enhancement contract when the asset backed security expires.

2. The method of claim 1, wherein the risk retention entity is an originator of the asset backed security.

3. The method of claim 1, wherein the risk retention entity is a securitizer of the asset backed security.

4. The method of claim 1, wherein the asset backed security comprises mortgage backed security.

5. The method of claim 4, wherein the asset backed security comprises a residential mortgage backed security.

6. The method of claim 4, wherein the asset backed security comprises a commercial mortgage backed security.

7. The method of claim 1, further including:
(d) determining a margin requirement for the risk retention entity that accounts for the margin as credit enhancement contract position.

8. The method of claim 7, wherein (d) comprises considering exposure for the risk retention entity's margin as credit enhancement contract position and other positions.

9. The method of claim 1, further including:
(e) adjusting the quantity of the margin as credit enhancement contracts when an amortization event occurs.

10. The method of claim 9, wherein the amortization event comprises prepayment of at least one loan.

11. The method of claim 1, further including:
(e) revaluing the margin as credit enhancement contract when a credit event occurs.

12. The method of claim 11, wherein the credit event comprises default of at least one loan.

13. The method of claim 1, wherein (c) comprises:
determining the change in value of the margin as credit enhancement contract to be zero when the asset backed security does not incur a loss.

14. The method of claim 1, wherein (c) comprises:
determining the value of the margin as credit enhancement contract to be a percentage of a loss incurred by the asset backed security.

15. A tangible computer-readable medium containing computer-executable instructions that cause at least one computer device to perform the steps comprising:
(a) assigning to a risk retention entity a long position for a margin as credit enhancement contract corresponding to a predetermined percentage of an asset backed security;
(b) assigning to a buyer of the asset backed security a short position for the margin as credit enhancement contract; and
(c) settling at a computer device the long and short positions of the margin as credit enhancement contract when the asset backed security expires.

16. The tangible computer-readable medium of claim 15, wherein (c) comprises:
determining the value of the margin as credit enhancement contract to be zero when the asset backed security does not incur a loss.

17. The tangible computer-readable medium of claim 15, wherein (c) comprises:
determining the value of the margin as credit enhancement contract to be a percentage of a loss incurred by the asset backed security.

18. The tangible computer-readable medium of claim 15, wherein the risk retention entity is an originator of the asset backed security.

19. The tangible computer-readable medium of claim 15, wherein the risk retention entity is a securitizer of the asset backed security.

20. A computer implemented method of administering an asset backed security risk retention requirement, the method comprising:
(a) assigning margin as credit enhancement contract positions to parties involved in the transfer of a corresponding asset backed security; and
(b) settling at a computer device the credit enhancement contract positions when the asset backed security expires.
